(19) United States
(12) Patent Application Publication
(10) Pub. No.: US 2022/0121915 A1
(43) Pub. Date: Apr. 21, 2022

(54) CONFIGURABLE BNN ASIC USING A NETWORK OF PROGRAMMABLE THRESHOLD LOGIC STANDARD CELLS

(71) Applicants: Arizona Board of Regents on behalf of Arizona State University, Scottsdale, AZ (US); The Texas A&M University System, College Station, TX (US)

(72) Inventors: Ankit Wagle, Tempe, AZ (US); Sarma Vrudhula, Chandler, AZ (US); Sunil Khatri, College Station, TX (US)

(21) Appl. No.: 17/504,279

(22) Filed: Oct. 18, 2021

Related U.S. Application Data
(60) Provisional application No. 63/092,780, filed on Oct. 16, 2020.

(51) Int. Cl. G06N 3/063; G06N 3/04

(52) U.S. Cl. CPC G06N 3/063; G06N 3/0454

(57) ABSTRACT

A configurable binary neural network (BNN) application-specific integrated circuit (ASIC) using a network of programmable threshold logic standard cells is provided. A new architecture is presented for a BNN that uses an optimal schedule for executing the operations of an arbitrary BNN. This architecture, also referred to herein as TULIP, is designed with the goal of maximizing energy efficiency per classification. At the top-level, TULIP consists of a collection of unique processing elements (TULIP-PEs) that are organized in a single instruction, multiple data (SIMD) fashion. Each TULIP-PE consists of a small network of binary neurons, and a small amount of local memory per neuron. Novel algorithms are presented herein for mapping arbitrary nodes of a BNN onto the TULIP-PEs. Comparison results show that TULIP is consistently 3× more energy-efficient than conventional designs, without any penalty in performance, area, or accuracy.

### RELATED APPLICATIONS

This application claims the benefit of provisional patent application Ser. No. 63/092,780, filed Oct. 16, 2020, the disclosure of which is hereby incorporated herein by reference in its entirety.

### FIELD OF THE DISCLOSURE

The present disclosure relates to programmable logic devices using threshold logic.

### BACKGROUND

Convolutional neural networks (CNNs) and deep neural networks (DNNs) have become dominant algorithmic frameworks in machine learning due to their remarkable success in many diverse applications, even performing better than humans in some situations. DNNs are now being applied to domains that require computation-intensive operations performed on very large data sets, using models with millions of parameters. Consequently, extensive ongoing efforts are being made to improve their performance and energy efficiency.

Regardless of the hardware platform (e.g., central processing unit (CPU), graphical processing unit (GPU), field-programmable gate array (FPGA), or application-specific integrated circuit (ASIC)) on which DNNs are deployed, the biggest challenge to improving their performance and energy efficiency has been the on-chip storage requirement. Cost and yield considerations limit the feasible on-chip storage to be one to two orders of magnitude smaller than what is required by many of the popular DNN models, forcing most of the parameters for even moderate size DNNs to be stored in off-chip dynamic random-access memory (DRAM). This results in large energy (>200×) and delay (>10×) penalties. This has accelerated efforts to drastically reduce the DRAM storage requirements and the associated access delays. Some well-known methods include weight and synapse pruning, quantization (i.e., reducing bit widths of inputs and weight), weight sharing, Huffman coding, and approximate arithmetic, to name a few.

Quantization remains the most effective technique to reduce memory requirements and computation latency. An extreme form of quantization is to replace the weights and data by binary values, which results in drastic reductions in both storage requirements and computational latency. The resulting networks, known as binary neural networks (BNNs), have been shown to have nearly the same accuracy as DNNs on some small networks (MNIST, SVHN, and CIFAR10), and similar accuracy to that of larger networks (AlexNet, GoogLeNet, ResNet).

BNNs provide a good tradeoff between reduced energy consumption and improved performance against classification accuracy. As a result, they have generated sustained interest in the machine learning community, among researchers in very large-scale integration (VLSI) architecture, circuits, and computer-aided design (CAD), and leading FPGA companies (e.g., Xilinx and Intel).

A DNN is a directed acyclic graph (DAG), in which the nodes represent operations such as matrix-vector products, thresholding applied to inner products, computation of the maximum of vectors, etc. In BNNs, such computations can be implemented almost entirely with binary operations. This makes FPGAs a particularly practical choice for implementing BNNs. Dedicated modules for each operation can be added to the design based on layer-specific requirements. These modules can be pipelined to maximize the throughput of the design. This approach amounts to mapping the nodes of the DAG, layer by layer, to corresponding modules on the FPGA. Often, the entire BNN can be mapped onto the FPGA. This design strategy is referred to as a dataflow architecture.

ASIC implementations of BNNs take a different approach. In order to execute any BNN, their basic computational engine consists of a collection of processing elements (PEs), which are comprised of dedicated circuits to perform the operations specific to neural networks such as convolution, max-pooling, rectified linear units (ReLUs), etc. Implementing a BNN on an ASIC next requires scheduling the execution of the nodes of the DAG on the PEs, while optimizing the intermediate storage and accesses to external memory. This approach, referred to as a loopback architecture, is the basis of many recent designs.

### SUMMARY

A configurable binary neural network (BNN) application-specific integrated circuit (ASIC) using a network of programmable threshold logic standard cells is provided. A new architecture is presented for a BNN that uses an optimal schedule for executing the operations of an arbitrary BNN. This architecture, also referred to herein as TULIP, is designed with the goal of maximizing energy efficiency per classification. At the top-level, TULIP consists of a collection of unique processing elements (TULIP-PEs) that are organized in a single instruction, multiple data (SIMD) fashion. Each TULIP-PE consists of a small network of binary neurons, and a small amount of local memory per neuron.

The unique aspect of the binary neuron is that it is implemented as a mixed-signal circuit that natively performs the inner product and thresholding operation of an artificial binary neuron. Moreover, the binary neuron, which is implemented as a single complementary metal-oxide semiconductor (CMOS) standard cell, is reconfigurable, and with a change in a single parameter, can implement all standard operations involved in a BNN. Novel algorithms are presented herein for mapping arbitrary nodes of a BNN onto the TULIP-PEs. TULIP was implemented as an ASIC in 40 nanometer (nm)-low power (LP) technology. To provide a fair comparison, a recently reported BNN that employs a conventional MAC-based arithmetic processor was also implemented in the same technology. The results show that TULIP is consistently 3× more energy-efficient than the conventional design, without any penalty in performance, area, or accuracy.

An exemplary embodiment provides a circuit for a configurable BNN. The circuit includes a processing element which comprises a network of binary neurons, wherein each binary neuron has a local register and a plurality of inputs, and is configurable with a threshold function. The processing element further includes connections between the network of binary neurons such that the network of binary neurons is fully connected.

Another exemplary embodiment provides a configurable BNN ASIC. The configurable BNN ASIC includes a processing unit comprising a plurality of processing elements programmable to perform a Boolean threshold function. Each of the plurality of processing elements comprises a binary neuron with a configurable threshold and a local register configured to store an output of the binary neuron. The configurable BNN ASIC further includes a processing unit controller coupled to the processing unit and configured to implement a BNN on the processing unit.

Another exemplary embodiment provides a method for programming a BNN on a neuron-based accelerator. The method includes obtaining a BNN expressed as a first network of threshold functions, decomposing each node of the first network of threshold functions into a second network of threshold functions, wherein a number of inputs of each node in the second network satisfies an input limit, and scheduling the second network on the binary neuron-based accelerator.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary binary neuron circuit.

FIG. 2 is a schematic diagram illustrating a design flow and the main components of an exemplary configurable binary neural network (BNN) application-specific integrated circuit (ASIC) described herein, also referred to as TULIP.

FIG. 3 is a schematic diagram of an exemplary binary neuron for a specialized processing element, also referred to as a TULIP-PE, in the TULIP of FIG. 2.

FIG. 4A is a schematic diagram illustrating an addition operation of an adder tree in the TULIP of FIG. 2.

FIG. 4B is a schematic diagram illustrating memory management of the adder tree in the TULIP of FIG. 2.

FIG. 4C is a schematic diagram illustrating an accumulation operation to add partial sums using the adder tree in the TULIP of FIG. 2.

FIG. 5A is a schematic diagram of an exemplary multi-cycle sequential comparator implemented using 3-input threshold functions with the TULIP of FIG. 2.

FIG. 5B is a schematic diagram of an exemplary max-pooling operation implemented with the TULIP of FIG. 2.

FIG. 6 is a schematic block diagram illustrating top-level architecture of an exemplary embodiment of TULIP.

FIG. 7 illustrates a synthesized embodiment of TULIP.

FIG. 8 is a schematic diagram of a generalized representation of an exemplary computer system that could include the TULIP of FIG. 2 and/or could be used to perform any of the methods or functions described above, such as designing or programming the TULIP.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

A configurable binary neural network (BNN) application-specific integrated circuit (ASIC) using a network of programmable threshold logic standard cells is provided. A new architecture is presented for a BNN that uses an optimal schedule for executing the operations of an arbitrary BNN. This architecture, also referred to herein as TULIP, is designed with the goal of maximizing energy efficiency per classification. At the top-level, TULIP consists of a collection of unique processing elements (TULIP-PEs) that are organized in a single instruction, multiple data (SIMD) fashion. Each TULIP-PE consists of a small network of binary neurons, and a small amount of local memory per neuron.

The unique aspect of the binary neuron is that it is implemented as a mixed-signal circuit that natively performs the inner product and thresholding operation of an artificial binary neuron. Moreover, the binary neuron, which is implemented as a single complementary metal-oxide semiconductor (CMOS) standard cell, is reconfigurable, and with a change in a single parameter, can implement all standard operations involved in a BNN. Novel algorithms are presented herein for mapping arbitrary nodes of a BNN onto the TULIP-PEs. TULIP was implemented as an ASIC in 40 nanometer (nm)-low power (LP) technology. To provide a fair comparison, a recently reported BNN that employs a conventional MAC-based arithmetic processor was also implemented in the same technology. The results show that TULIP is consistently 3× more energy-efficient than the conventional design, without any penalty in performance, area, or accuracy.

I. Introduction

This disclosure describes TULIP, a new ASIC architecture to realize BNNs, designed with the aim of maximizing their energy efficiency. Although TULIP falls under the category of a loopback architecture mentioned above, its processing element (TULIP-PE) is radically different from the existing BNN accelerators, which leads to new algorithms to map BNNs onto TULIP. Certain features of TULIP are summarized below.
1) TULIP is a scalable SIMD machine, consisting of a collection of concurrently executing TULIP-PEs.
2) In addition to the design of TULIP, a new approach is described to map any BNN (any number of nodes and nodes with arbitrary fan-in) onto TULIP.
3) The architecture of a TULIP-PE is radically different compared to the PEs in other BNN accelerators. It consists of a small, fully connected network of binary neurons each with a small, fixed fan-in. A binary neuron is implemented as a mixed-signal circuit that natively computes the inner product and threshold operation of a neuron. The mixed-signal binary neuron is implemented as a single standard cell that is just a little larger than a conventional flipflop. Moreover, the mixed-signal binary neuron is easily configured to perform all the primitive operations required in a BNN. By suitably applying control inputs, a TULIP-PE can be configured to perform all the operations required in a BNN, namely the accumulation of partial sums, comparison, max-pooling, and rectified linear unit (ReLU) operations. Hence, exactly one such cell is needed to implement all necessary primitive functions in a BNN.
4) Because the binary neurons within a TULIP-PE have a fixed fan-in, the function of a binary neuron with an arbitrarily large fan-in has to be decomposed into a sequence of operations that have to be scheduled on the TULIP-PE. A novel scheduling algorithm for this purpose is described.
5) Due to the small area and delay of a single TULIP-PE, several of these can be used within the same area that is occupied by a conventional MAC, and they can be operated in parallel. This, combined with the uniformity of the computation at the individual node and network levels, leads to significant improvement in energy efficiency, without sacrificing the area or performance.

Section II describes a generic architecture of a binary neuron, which is commonly referred to as a threshold gate. Here, only the key characteristics of such an element are described and the details of the circuit design are omitted. There are several recent publications describing the architecture of a threshold logic gate, any one of which would be suitable for TULIP. Section III shows how the function of an arbitrarily large binary neuron can be efficiently decomposed into a computation tree consisting of smaller binary neurons that are mapped to the PEs of TULIP. Section IV describes how the novel PE is constructed and how it can be reconfigured to perform the various operations of the BNN. Section V compares the throughput, power, and area of TULIP against state of the art approaches.

II. Binary Neurons

A Boolean function ƒ(x₁, x₂, . . . , xₙ) is called a threshold function if there exist weights wᵢ for i=1, 2, . . . , n and a threshold T such that

ƒ(x₁,x₂, . . . ,xₙ)=1 ⇔Σᵢ₌₁ⁿwᵢxᵢ≥T Equation 1

where Σ denotes the arithmetic sum. Thus, a threshold function can be represented as (W,T)=[w₁, w₂, . . . , wₙ; T]. Without loss of generality, the weights wᵢ and threshold T can be integers. An example of a threshold function is ƒ(a, b, c, d)=ab∨ac∨ad∨bcd, with [w₁, w₂, . . . , wₙ; T]=[2,1,1,1; 3].

Threshold logic was first introduced by McCulloch and Pitts (as described in W. S. McCulloch and W. Pitts, A Logical Calculus of the Ideas Immanent in Nervous Activity, MIT Press, Cambridge, Mass., USA, 1988) in 1943 as a simple model of an artificial neuron. Since then, there has been an extensive body of work exploring the many theoretical and practical aspects of threshold logic. The recent resurgence of interest in neural networks has rekindled interest in threshold logic and its circuit realizations. A binary neuron is a threshold logic gate and is therefore a circuit that realizes a threshold function. Although there exist conventional static CMOS logic implementations of threshold functions, they are inefficient in performance, power, and area. Instead, the binary neuron described herein is a mixed-signal implementation in which the defining inequality (Equation 1) is evaluated by directly comparing some electrical quantity such as charge, voltage or current. Interest in binary neurons continues to grow with new architectures incorporating resistive random-access memory (RRAMs), spin transfer torque magnetic tunnel junctions (STT-MTJs), and flash transistors, demonstrating substantial improvements in performance, power, and area compared to their CMOS equivalents.

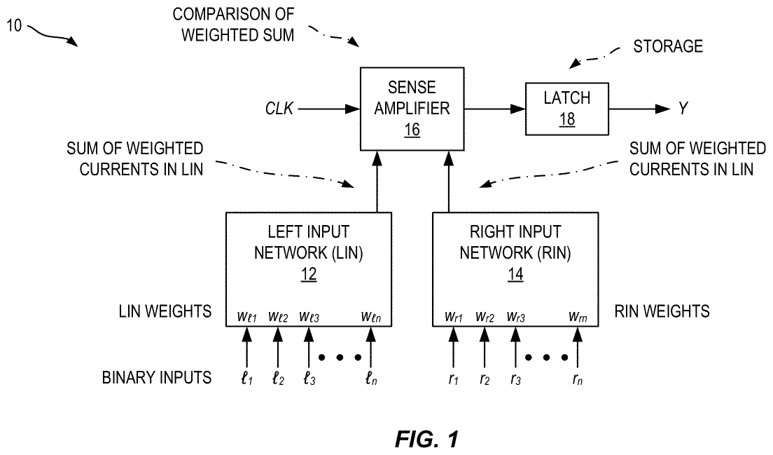

FIG. 1 is a block diagram of an exemplary binary neuron 10 circuit. It consists of four components: a left input network (LIN) 12, a right input network (RIN) 14, a sense amplifier 16, and a latch 18. The key principle under which it operates is as follows. The outputs of the sense amplifier 16 are differential digital signals, with (1,0) and (0,1) setting and resetting the latch 18 respectively. The latch state remains unchanged when its inputs are (0,0) or (1,1). The weights wᵢ that define the threshold function (Equation 1) are realized in ways that vary among different implementations, but the common feature of all implementations is that they determine the charge, voltage or current of the LIN 12 and RIN 14 once the inputs are applied. That is, the LIN 12 and RIN 14 are designed so that the charge, voltage, or current of the path that xᵢ controls will be proportional to wᵢ.

The inputs (x₁, x₂, . . . , xₙ) of a threshold function are mapped to the inputs of the LIN 12 ( [symbol] ₁, [symbol] ₂, . . . , [symbol] ₙ) and RIN 14 (r₁, r₂, . . . , rₙ) in such a way that for every on-set (off-set) minterm, the charge, voltage or current of the LIN 12 (RIN 14) reliably exceeds that of the RIN 14 (LIN 12) causing the sense amplifier 16 to set (reset) the latch 18. Ensuring that the inputs to the LIN 12 and RIN 14 are applied at a clock edge turns the circuit into a multi-input, edge-triggered flipflop that computes the Boolean threshold function.

III. Binary Neural Network Using Binary Neurons

A threshold function with a large number of inputs needs to be decomposed into a network (directed acyclic graph or DAG) of threshold functions with bounded fan-in, each of which can be directly realized by a binary neuron. In such a network, each layer (e.g., level in the DAG) can consist of a collection of threshold functions ƒᵢⱼ, where i is the index of the layer and j is the index of the function within any layer i. The conventional approach taken by all recently reported BNN architectures is to accumulate the partial sums (i.e., the left hand side of the inequality at Equation 1) using standard digital circuits using multiply and accumulate operations. The final thresholding operation uses a conventional binary comparator. This approach does not exploit the underlying special nature of the functions being computed, namely, the fact that they are threshold functions. Another possible disadvantage of this approach is that it may use arithmetic operators of maximum width, regardless of how small the results of the partial sums are. In general, adders of varying width may be used.

There are two basic approaches to decompose a given threshold function into a network of bounded fan-in threshold functions. Several heuristic approaches view the threshold function as any other logic function and use existing logic synthesis tools to perform a technology-independent resynthesis into a traditional logic network. This logic network is searched for subgraphs that are bounded fan-in threshold functions. An exact and more elegant algorithm is presented by Annampedu and Wagh (as described in Viswanath Annampedu and Meghanad D. Wagh, “Decomposition of Threshold Functions into Bounded Fan-In Threshold Functions,” in Information and Computation, 227:84-101, 2013). It directly constructs a network of bounded fan-in threshold functions, in which each function performs thresholding on partial sums. Unfortunately, both these approaches result in extremely large networks.

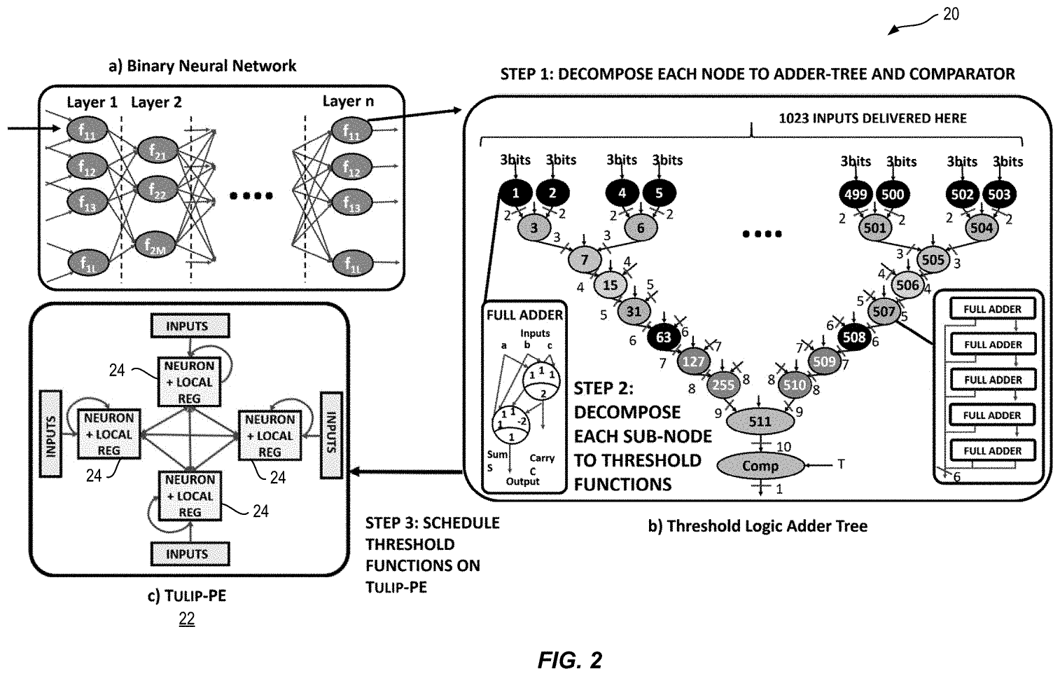

FIG. 2 is a schematic diagram illustrating a design flow and the main components of an exemplary embodiment of TULIP 20. The architecture of TULIP 20 combines both the above-described approaches in a novel way. First, a BNN is expressed as a network 22 of threshold functions ƒᵢⱼ (see part a). Next, the left-hand side sum of each threshold function is decomposed into a tree of adders (see part b) of bounded size, and each such adder is realized by the repeated use of one configurable binary neuron (see insets of part b). This eliminates the waste incurred by conventional methods of accumulation that use operators of max-width.

In part b of FIG. 2, the labels inside the node show the order in which that node is executed on a TULIP-PE 22 for a threshold function with 1023 inputs. Note that although accumulation can be implemented by using conventional adders of varying sizes, the key difference with TULIP 20 is that all the operations that arise in a BNN (addition, accumulation, comparison, and max-pooling) are implemented by the same, single configurable binary neuron in TULIP 20.

The main processing element in TULIP 20, the TULIP-PE 22, consists of a complete network of four configurable binary neurons 24 (as shown in part c). The operations in the adder tree, as well as all the other operations in a BNN, are scheduled to be executed on a TULIP-PE 22 so as to minimize the storage required for intermediate results. Each full adder is implemented as a cascade of two binary neurons 24 (see left inset of part b). Larger width adders are implemented using a cascade of full adders (right inset of part b). This can be changed to implement a two-bit or three-bit carry-lookahead addition. Doing so would require a binary neuron 24 with a different set of weights, and could increase the throughput at the expense of a small increase in area and power.

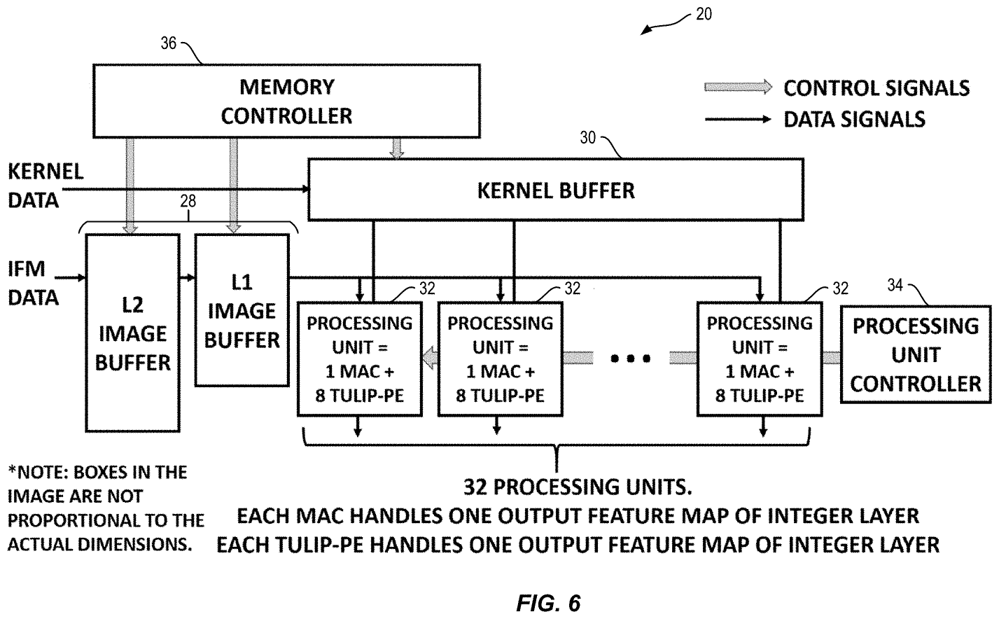

Finally, the top-level structure of TULIP 20 consists of a number of TULIP-PEs 22 along with image and kernel buffers (as discussed further below with respect to FIG. 6). TULIP 20 is scalable, i.e., the throughput can simply be increased linearly by adding TULIP-PEs 22 and using larger image and kernel buffers, without changing the scheduling algorithm.

IV. Tulip Implementation

TULIP 20 involves the co-design and co-optimization of novel hardware and scheduler optimizations that together perform the operations of the BNN. In this section, the hardware architecture of the TULIP-PE 22 is discussed first. Then the scheduling algorithm needed to perform various operations such as addition, comparison, etc. is discussed. Finally, the top-level architecture is described, which uses an array of TULIP-PEs 22 to realize the entire BNN.

A. Hardware Architecture of TULIP-PE

A TULIP-PE 22 (part c of FIG. 2) has four fully connected binary neurons 24, referred to as N₁, . . . , N₄, each with 16-bit local registers.

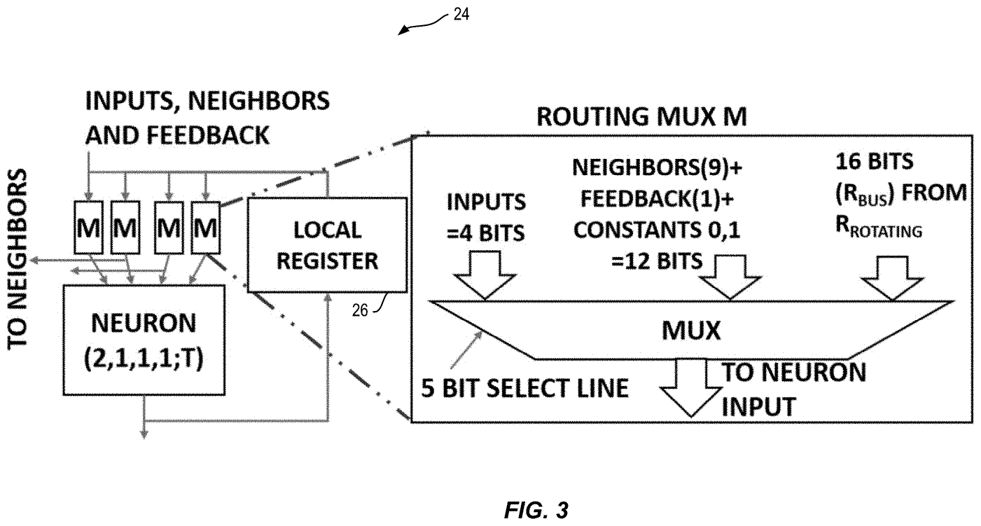

FIG. 3 is a schematic diagram of an exemplary binary neuron 24 for a TULIP-PE 22 in the TULIP 20 of FIG. 2. Inter-neuron communication is implemented using multiplexers. Each binary neuron 24 has four inputs a, b, c, and d, with weights 2, 1, 1, and 1 respectively and a threshold T that is modified using digital control signals (e.g., adapted for the particular computation to be performed). The number of binary neurons 24 in each TULIP-PE 22 is determined based on the computational requirements. The minimum number of binary neurons 24 needed to perform addition, comparison, max-pooling, and ReLU was found to be four, and was hence chosen for the illustrated embodiment. Other embodiments may use additional or fewer neurons.

All four binary neurons 24 of the TULIP-PE 22 share their inputs b and c. This is done so that the binary neuron 24 can fetch data from its local register 26, and broadcast it to all other binary neurons 24. The local register 26 is constructed using latches. As opposed to global registers, the local registers 26 allow the binary neurons 24 to access temporarily stored data faster, and also reduce the power consumption per read/write access.

B. Decomposition and Scheduling of an Adder Tree

This section describes how a threshold function ƒᵢⱼ in the BNN (see part a of FIG. 2) is computed on a single TULIP-PE 22 (see part b of FIG. 2). The node ƒᵢⱼ computes the predicate S≥T, where S=Σᵢwᵢxᵢ. The adder tree shown in FIG. 2 is a binary decomposition of the S into partial sums, with the leaf nodes (shown at the top) computing the sum of three inputs. The computation of partial sums uses a reverse post order (RPO) scheme, which schedules the computation of a sum at a given node after both the sums associated with the left and right subtrees rooted at its left and right nodes have been computed. Therefore, the number of bits required for the output of a node is one more than the number of bits of its inputs. In part b of FIG. 2, the numeric label shown inside a node indicates its position in the RPO. The key property of the RPO is that it minimizes the maximum amount of storage required to store the intermediate results.

Consider the N-input adder tree shown in part b of FIG. 2. The adder tree has └log₂ N┘ levels, assuming that the leaf nodes are at level 0. Let v be a node at level i in the adder tree, and vₗ and vᵣ be its left and right subtrees (both at level i−1). Let mᵢ denote the maximum storage used for all computations up to and including a node at level i. Since the node at level i corresponds to an i+1-input adder, the storage required for the output of a node at level i is i+2. Since the adder tree is balanced, without the loss of generality, it can be assumed that vₗ is scheduled before vᵣ. To compute v, it is only required to store the output of vₗ, which requires i+1 bits of storage. The maximum storage used to compute vₗ is mᵢ₋₁. Hence mᵢ=i+1+mᵢ₋₁, with m₀=2. Therefore, mᵢ=(i²+3i)/2+2. As the highest level is └log₂ N┘−1, the maximum required storage will be (└log₂N┘²+└log₂N┘)/2+1. Therefore, an adder tree has a storage requirement complexity of 0(log(N)).

C. Addition and Accumulation Operation

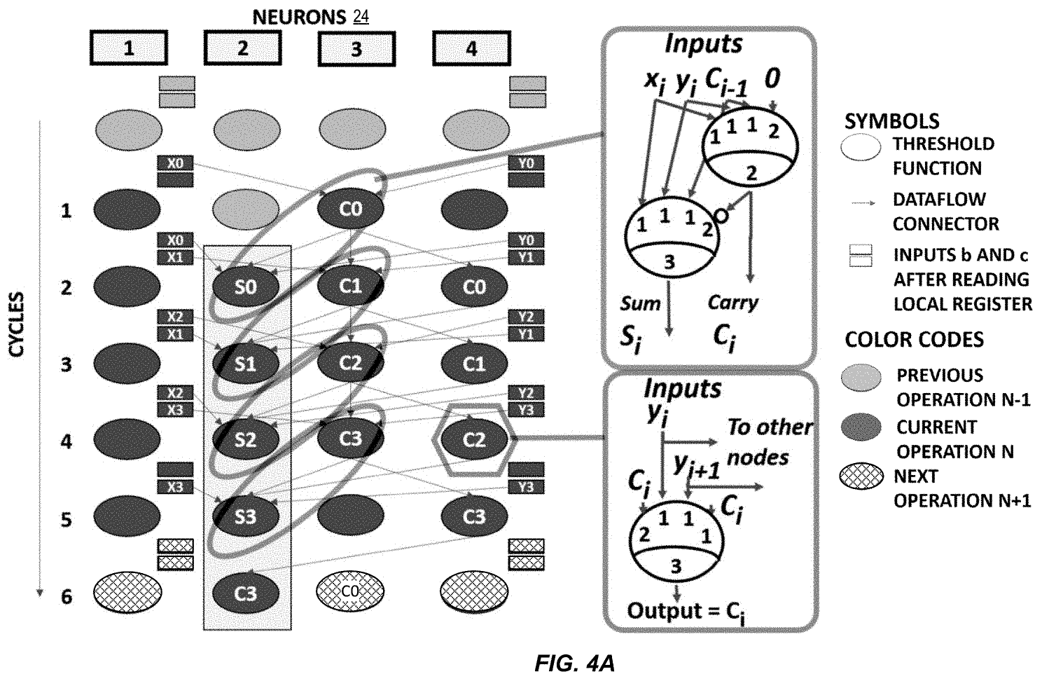

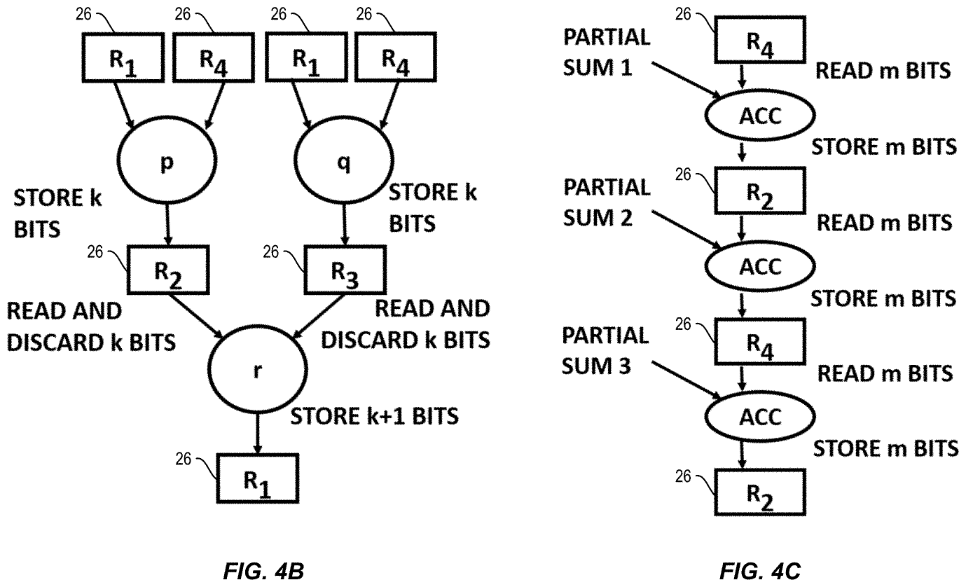

FIG. 4A is a schematic diagram illustrating an addition operation of the adder tree in the TULIP 20 of FIG. 2. For a node p in the adder tree, assume neurons 24 N₁ and N₄ broadcast two operands from R₁ and R₄, using the threshold function shown in the bottom-right inset of FIG. 4A. Then, N₂ and N₃ will be used to generate the sum and carry bits of p, over multiple cycles, using the threshold function shown in the top-right inset of FIG. 4A. Since the sum bits are computed on N₂, the final result of p will be stored in the local register 26 (see FIG. 3) of N₂, i.e. R₂. FIG. 4A demonstrates the schedule for 4-bit addition (see node 15 of the adder tree in part b of FIG. 2) using two 4-bit operands x and y, i.e. {x₃, x₂, x₁, x₀} and {y₃, y₂, y₁, y₀}. The final result of x+y is stored in R₂.

FIG. 4B is a schematic diagram illustrating memory management of the adder tree of the TULIP 20 of FIG. 2. Now, consider nodes p, q, and r in the adder tree. r sums the results of p and q. Since the result of p is stored in R₂ (the local register 26 of neuron 24 N₂), the result of q is stored in R₃ to allow simultaneous reading of operands while computing r. r reads R₂ and R₃ to generate its sum bits on N₁, and carry on N₄. The memory used by the results of p and q can now be freed. Each addition operation stores its result to a specific memory location in the local registers 26 so that the data in the memory is not prematurely overwritten during RPO scheduling.

FIG. 4C is a schematic diagram illustrating an accumulation operation to add partial sums using the adder tree in the TULIP 20 of FIG. 2. The adder tree described herein handles up to 10-bit addition on a TULIP-PE 22. However, this range can be further extended by configuring the TULIP-PE 22 for accumulation. Numbers can be added to an accumulated term stored in the local registers 26 using a multi-cycle addition operation. The addition of an input number p with the accumulated term q is shown. Since the same local register 26 cannot provide the operands and store the results simultaneously, the storage of q is alternated between the local registers 26 R₂ and R₄ for each new accumulation.

D. Comparison, Batch Normalization, Max-Pooling, ReLU Operation

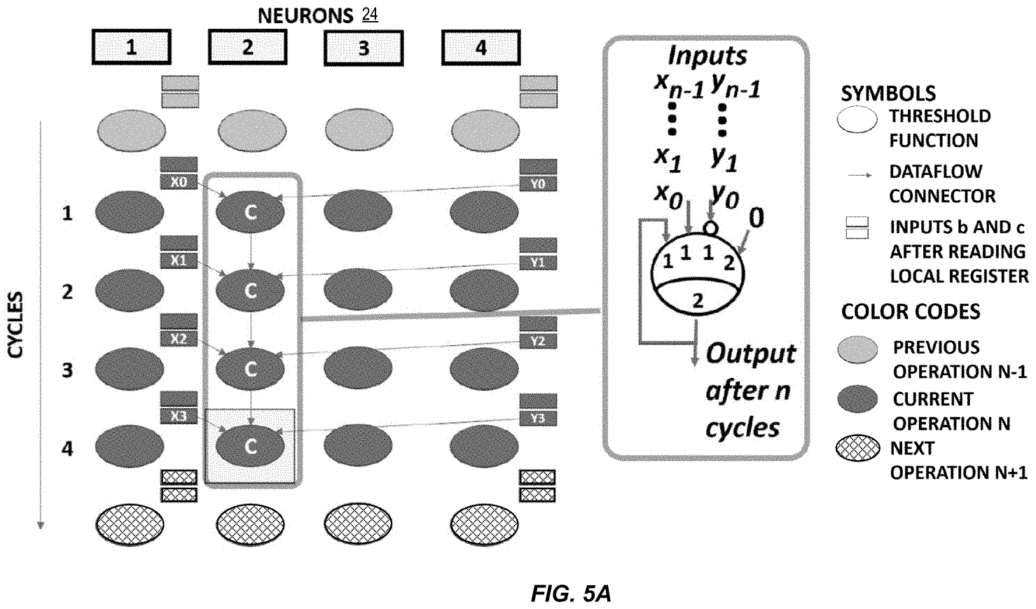

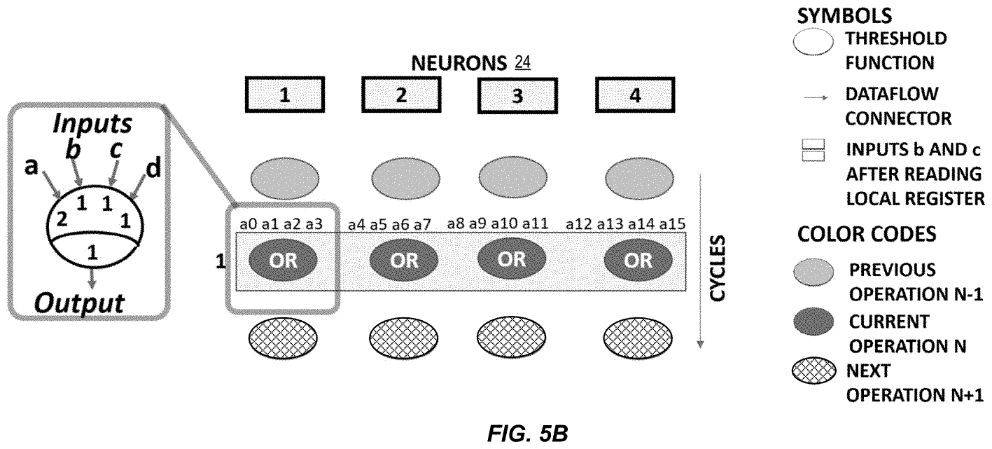

Comparison: FIG. 5A is a schematic diagram of an exemplary multi-cycle sequential comparator implemented using 3-input threshold functions with the TULIP 20 of FIG. 2. This is the first implementation of a sequential comparator that uses 3-input neurons 24. Two n-bit numbers x and y that need to be compared are serially delivered from least significant bit (LSB) to most significant bit (MSB) to the comparator that returns the value of the predicate (x>y). In the first cycle, the LSBs of both numbers are compared. In the ith cycle of the comparison, if xᵢ>yᵢ, then the output is 1, and if xᵢ<yᵢ, then the output is 0. If xᵢ=yᵢ, then the result of the (i−1)th cycle is retained. The inset in FIG. 5A shows the logic for bitwise comparison. At the end of n cycles, the output is 1 if x>y, and 0 otherwise. The schedule of a 4-bit comparison is shown in FIG. 5A. The 4-bit inputs x and y are streamed to the comparator either through the local registers or through the input channels.

Batch Normalization: This operation performs biasing of an input value in BNNs. For BNNs, it is realized by subtracting the value of bias from the threshold T of the binary neuron (as described in Taylor Simons and Dah-Jye Lee, “A Review of Binarized Neural Networks,” in Electronics, 8(6):661, 2019). Therefore, batch normalization in TULIP 20 is implemented using the comparison operation.

Max-pooling: FIG. 5B is a schematic diagram of an exemplary max-pooling operation implemented with the TULIP 20 of FIG. 2. In a BNN, this operation is an OR operation on a pooling window of layer outputs. This can be implemented using a threshold gate. Each of the neurons 24 implement one four-input OR function, without the need for local registers. The schedule for this operation requires a single cycle as shown in FIG. 5B.

ReLU: The implementation of ReLU in TULIP is also an extension of the comparator schedule shown above. In ReLU, if the input value is greater than threshold T, then the output gets the value of the input, otherwise, it is 0. This is achieved by ANDing the result of the input value with the comparator's result, using a 2-input threshold function [1,1; 2].

E. Top Level View of the Architecture

FIG. 6 is a schematic block diagram illustrating top-level architecture of an exemplary embodiment of TULIP 20. It was designed to deliver high energy efficiency per operation while matching the throughput for the state-of-the-art implementations. This architecture consists of four major types of components: an image buffer 28, a kernel buffer 30, one or more processing units 32, and a processing unit controller 34. The kernel buffer 30 is a shift-register which stores the weights of the BNN. Weights are populated on-chip before the inputs are loaded. The image buffer 28 is a two-stage standard cell memory (SCM) named L2 and L1. Its use reduces off-chip communication. A memory controller 36 controls operation of the image buffer 28 and the kernel buffer 30. The memory controller 36 and the processing unit controller 34 may be implemented in a single logic circuit or in separate logic circuits.

In this architecture, 32 input feature maps (IFMs) are loaded on-chip into L2 on a pixel-by-pixel basis. Memory can be scaled to store fewer or more IFMs. Once L2 is loaded with IFMs, L1 starts fetching the window of IFM pixels needed for the convolution operation, on a window-by-window basis. This window of input pixels is broadcasted to all the processing units 32 present in the design. The processing units 32 are responsible for performing the convolution. The processing units 32 also receive the appropriate weights from the kernel buffer 30.

A processing unit 32 only triggers after necessary inputs and weights are received. The inputs and weights are multiplied using XNOR gates, to generate product terms. The processing unit 32 has two components for accumulating the product terms: a MAC unit and eight TULIP-PEs 22 (see FIG. 2). A TULIP-PE 22 is used to handle an output feature map (OFM) of the binary layers. Although the TULIP-PEs 22 are capable of handling the integer layers as well, it would result in reduced throughput. This is because the TULIP-PEs 22 require several cycles for integer additions, which becomes progressively worse as the size of the operands increases. Hence, MACs are used for integer layers.

The controllers used in the MAC units are simple counters. However, for the TULIP-PEs 22, a reconfigurable sequence generator is used. This sequence generator follows the RPO schedule and controls the local registers and the multiplexers of the TULIP-PEs 22. The control signals are broadcast to all the processing units 32. The design of the processing unit controller 34 is simple and has a negligible impact on the area and power of the overall TULIP architecture. The TULIP architecture also incorporates a clock gating strategy whenever a part of the design is not used. The necessary clock gating signals are also generated by the processing unit controller 34.

Although the TULIP architecture locks its configuration to a specific set of components for delivering weights and inputs, it can easily be tailored for a given application. For example, if a BNN does not have integer layers, then the MAC units can be removed, and the multi-bit input buffers can be trimmed to 1-bit input buffers. Various weight and input distribution techniques can also be used by stacking the processing units in a 2-D arrangement instead of a 1-D configuration.

V. Evaluation Results

A. Evaluation Setup

An embodiment of the TULIP architecture was built based on the hardware neuron described in PCT Patent Application No. PCT/US2020/41653, which is incorporated herein by reference in its entirety. The neuron was re-implemented in a 40 nm technology, programmed to [2,1,1,1; T], and characterized across corners (SS 0: 81V 125° C., TT 0.9V 25° C. and FF 0.99V 0° C.). The value of T is switched during runtime by changing the appropriate control signals of the neuron 24.

Table I demonstrates that this hardware neuron is substantially better than its conventional CMOS standard cell equivalent in terms of area, power, and delay. This is significant since TULIP 20 uses this neuron 24 for all operations (computation of partial sums, comparison, ReLU, and max-pool).

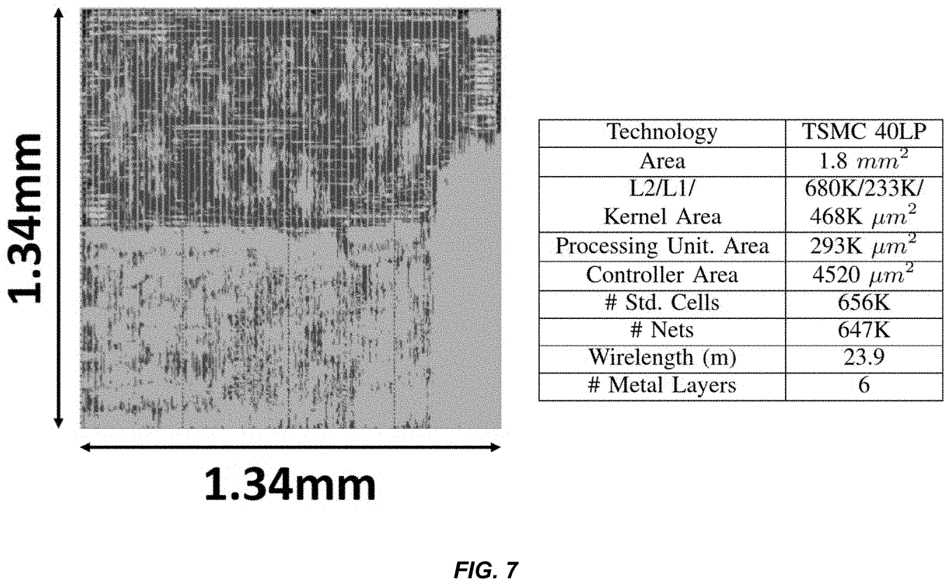

FIG. 7 illustrates a synthesized embodiment of TULIP 20. This embodiment was synthesized and placed using TSMC 40 nm-LP standard cells with Cadence Genus© and Innovus©. The VCD file generated using real BNN workloads was used for power analysis, to model switching activity accurately.

TABLE I
Hardware neuron versus standard cell neuron

| | Hardware | Logical | |
|---|---|---|---|
| | Neuron | Equivalent | ×Improvement |
| Area (μm²) | 15.6 | 27 | 1.8× |
| Power (μW) | 4.46 | 6.72 | 1.5× |
| Worst Delay (ps) | 384 | 697 | 1.8× |

TULIP 20 is compared with a recent BNN design named YodaNN (as described R. Andri, L. Cavigelli, D. Rossi, and L. Benini, “YodaNN: An Architecture for Ultralow Power Binary-Weight CNN Acceleration, in IEEE Transactions on Computer-Aided Design of Integrated Circuits and Systems, PP: 1-1, March 2017) which was designed in 65 nm UMC technology. To make a fair comparison, the entire YodaNN design is implemented in the same technology as TULIP 20 (40 nm-LP from TSMC), and synthesized, placed and routed in the same manner. Both TULIP 20 and YodaNN were designed for up to 12-bit inputs, with binary weights. Therefore, for YodaNN, clock gating is added for 11/12 input bits when binary layers are evaluated.

There are other ASIC architectures available, such as XNORBIN (as described in A. Al Bahou, G. Karunaratne, R. Andri, L. Cavigelli, and L. Benini, “XNORBIN: A 95 TOp/s/W Hardware Accelerator for Binary Convolutional Neural Networks,” in 2018 IEEE Symposium in Low-Power and High-Speed Chips (COOL CHIPS), pages 1-3, 2018), which use more advanced memory techniques to improve energy efficiency. However, these architectures do not support integer layers and are therefore not suitable for comparison. Although YodaNN does not report the throughput and energy efficiency for fully connected layers, the throughput and power are estimated by performing an element-wise matrix multiplication using the MAC units present in their architecture.

B. Evaluation of TULIP-PE Against MAC

In Table II, the 15-bit reconfigurable MAC unit based on the design present in YodaNN is compared against the TULIP-PE 22 module. The MAC unit used in YodaNN is capable of handling 3×3, 5×5 and 7×7 kernel sizes. Note that both the MAC unit and TULIP-PE 22 are capable of handling integer inputs and binary weights. In large BNN architectures such as AlexNet, the initial layers are integer layers, while the rest of the layers are binary. YodaNN uses MAC units for all layers while TULIP 20 uses TULIP-PEs 22 for binary layers and simplified MACs (which support only 5×5 and 7×7 kernel windows) for integer layers.

TABLE II
Comparison of fully reconfigurable MAC unit with TULIP-PE

| Single | YodaNN MAC | TULIP-PE | Ratio |
|---|---|---|---|
| PE Metrics | (B) | (T) | (X) (B/T) |
| Area (μm²) | 3.54E+04 | 1.53E+03 | 23.18 |
| Power (mW) | 7.17 | 0.12 | 59.75 |
| Cycles | 17 | 441 | 0.038 |
| Time period (ns) | 2300 | 2300 | 1 |
| Time (ns) | 39 | 1014 | 0.038 |

Since the computation technique between YodaNN and TULIP 20 differs only for binary layers, the comparison of the MAC and the TULIP 20 is done for the binary layers. That is, both modules perform the weighted sum for binary activations and binary weights of 288 inputs, i.e., 3×3 kernel for 32 IFMs. Based on the Table II, the TULIP-PE 22 is 23.18× smaller than the MAC unit and consumes 60× less power. However, it consumes 27× more time as compared to the MAC unit, since it performs bit-level addition. The power delay product of a TULIP-PE 22 is 2.27× lower than the MAC unit, while at the same time being 23× smaller than the MAC.

The use of an adder tree-based schedule helps the TULIP-PE 22 deliver a better power-delay product than a conventional MAC unit. Furthermore, since a MAC unit is not capable of operations such as comparison, max-pooling, etc., the data is sent to other parts of the chip for these operations in YodaNN. However, the TULIP-PE 22 is capable of preserving the data locality and can perform the comparison and max-pooling operations internally, without the need to move the data to other modules, which saves additional energy.

C. Evaluation of the TULIP Architecture

The following notation is used for evaluating the TULIP architecture. For 2-D convolution, let (x₁, y₁, z₁) and (x₂, y₂, z₂) denote the dimensions of the IFMs and OFMs respectively. Let the kernel window size be (k×k).

The number of processing units in TULIP can be scaled to suit the application. However, for the sake of evaluation, TULIP was designed with 32 simplified MAC units and 256 TULIP-PEs, to ensure that the chip area of TULIP matches that of YodaNN. Note that the simplified MAC unit is not reconfigurable, and hence consumes significantly lower area and power than the MAC presented in YodaNN. Therefore, for TULIP, convolution is done in batches of 32 OFMs at a time for integer layers, and 256 OFMs at a time for binary layers. Since the IFMs are re-fetched for each batch of OFMs, they are fetched Z=z₂/32 times for integer layers and z₂/256 times for binary layers. The YodaNN architecture uses 32 fully reconfigurable MAC units and occupies the same area as TULIP. Therefore, the number of times YodaNN fetches IFMs (Z)=z₂/32. Additionally, when the kernel size is small (k≤5), the MAC units in both the designs can fetch twice the number of IFMs. Since the TULIP can initiate more OFMs for binary layers, it significantly reduces the number of times an input needs to be fetched.

For this evaluation, both the YodaNN and TULIP architecture load 32 IFMs at a time on-chip. This specification can however be changed to meet the application requirements. If the total IFMs cannot fit on-chip, the OFMs are generated in pieces of P partial results. These partial results are later accumulated on-chip to generate the final OFM. For both the architectures, P=z₁/32. The total number of operations is counted by considering addition and multiplication separately. For a 2-D convolution layer, the total multiply and accumulate operations in TULIP are 2z₁k²x₂y₂z₂, and for comparison of each accumulated sum with T, it is x₂y₂z₂.

For AlexNet, Table III compares the number of times the inputs need to be re-fetched (Z), and the number of times the P partial products need to be computed for both YodaNN and TULIP. Since both the designs use MAC units for integer layers, there is no difference in both P and Z. However, for binary layers, TULIP demonstrates 3× to 4× improvement in overall input-re-fetch (indicated by P×Z) as compared to the YodaNN architecture.

TABLE III
Effect of input fetch requirements based
on AlexNet layers for YodaNN and TULIP

| Convolution | | YodaNN | | | TULIP | | |
|---|---|---|---|---|---|---|---|
| Layers | Parts | P | Z | P × Z | P | Z | P × Z |
| 1 (Integer) | 4 | 1 | 3 | 3 | 1 | 3 | 3 |
| 2 (Integer) | 1 | 2 | 8 | 16 | 2 | 8 | 16 |
| 3 (Binary) | 1 | 4 | 12 | 48 | 8 | 2 | 16 |
| 4 (Binary) | 1 | 6 | 12 | 72 | 12 | 2 | 24 |
| 5 (Binary) | 1 | 6 | 8 | 48 | 12 | 1 | 12 |

Table IV and Table V compare the characteristics of YodaNN with TULIP. Table IV presents the results for the convolution layers and Table V presents the results for the entire BNN. The TULIP architecture outperforms YodaNN in energy efficiency by about 3× for the convolution layers. This is due to the combined use of adder tree-based schedule, coupled with clock gating. The energy efficiency also increases due to better input re-use, which allows the throughput to improve slightly. Considering all layers, TULIP's energy efficiency is 2.4× better than YodaNN. This is because memory consumes significantly more energy than the processing units when executing fully connected layers, which slightly diminishes the energy efficiency achieved in the convolution layers. The results also show that the gains are consistent across different neural networks.

TABLE IV
Comparison of YodaNN with TULIP architecture for accelerating
convolution layers of standard datasets

| | BinaryNet | | | AlexNet | | |
|---|---|---|---|---|---|---|
| Conv only | CIFAR10 | | | ImageNet | | |
| Dataset | YodaNN | TULIP (X) | | YodaNN | TULIP (X) | |
| Op. (MOp) | 1017 | 1017 | (1.0) | 2050 | 2050 | (1.0) |
| Perf. (GOp/s) | 47.6 | 49.5 | (1.0) | 72.9 | 79.1 | (1.1) |
| Energy (μJ) | 472.6 | 159.1 | (3.0) | 678.8 | 224.5 | (3.0) |
| Time (ms) | 21.4 | 20.6 | (1.0) | 28.1 | 25.9 | (1.1) |
| En. Eff. (TOp/s/W) | 2.2 | 6.4 | (3.0) | 3.0 | 9.1 | (3.0) |

TABLE V
Comparison of YodaNN with TULIP architecture for
accelerating entire BNNs of standard datasets

| | BinaryNet | | | AlexNet | | |
|---|---|---|---|---|---|---|
| All Layers | CIFAR10 | | | ImageNet | | |
| Dataset | YodaNN | TULIP (X) | | YodaNN | TULIP (X) | |
| Op. (MOp) | 1036 | 1036 | (1.0) | 2168 | 2168 | (1.0) |
| Perf. (GOp/s) | 37.7 | 35.8 | (0.9) | 12.3 | 13.1 | (1.1) |
| Energy (μJ) | 495.2 | 183.9 | (2.7) | 1013.3 | 427.5 | (2.4) |
| Time (ms) | 27.5 | 28.9 | (0.9) | 176.8 | 165.0 | (1.1) |
| En. Eff. (TOp/s/W) | 2.1 | 5.6 | (2.7) | 2.1 | 5.1 | (2.4) |

VI. Computer System

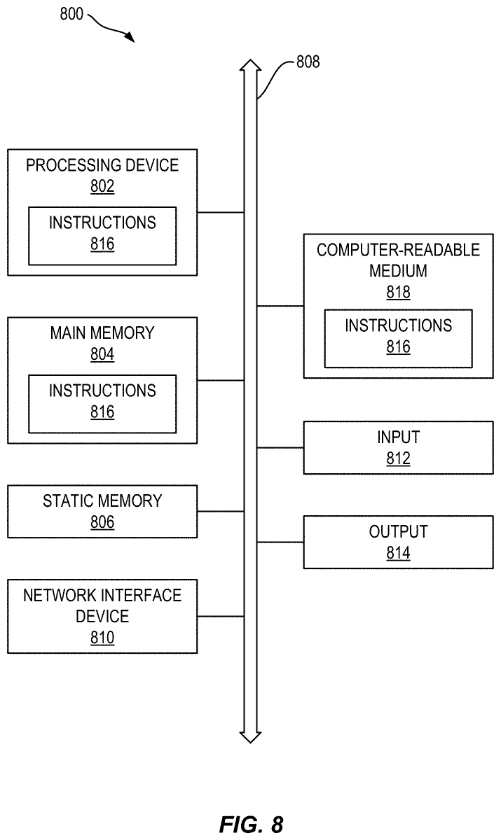

FIG. 8 is a schematic diagram of a generalized representation of an exemplary computer system 800 that could include the TULIP of FIG. 2 and/or could be used to perform any of the methods or functions described above, such as designing or programming the TULIP. In this regard, the computer system 800 may be a circuit or circuits included in an electronic board card, such as, a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 800 in this embodiment includes a processing device 802 (e.g., the TULIP of FIG. 2) or processor, a main memory 804 (e.g., read-only memory (ROM), flash memory, dynamic random-access memory (DRAM), such as synchronous DRAM (SDRAM), etc.), and a static memory 806 (e.g., flash memory, SRAM, etc.), which may communicate with each other via a data bus 808. Alternatively, the processing device 802 may be connected to the main memory 804 and/or static memory 806 directly or via some other connectivity means. In an exemplary aspect, the processing device 802 may be the TULIP of FIG. 2 and/or could be used to perform any of the methods or functions described above, such as designing or programming the TULIP.

The processing device 802 represents one or more general-purpose processing devices, such as a microprocessor, central processing unit (CPU), or the like. More particularly, the processing device 802 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 802 is configured to execute processing logic in instructions for performing the operations and steps discussed herein.

The various illustrative logical blocks, modules, and circuits described in connection with the embodiments disclosed herein may be implemented or performed with the processing device 802, which may be an FPGA, a digital signal processor (DSP), an ASIC, or other programmable logic device, a discrete gate or transistor logic, discrete hardware components, or any combination thereof designed to perform the functions described herein. Furthermore, the processing device 802 may be a microprocessor, or may be any conventional processor, controller, microcontroller, or state machine. The processing device 802 may also be implemented as a combination of computing devices (e.g., a combination of a DSP and a microprocessor, a plurality of microprocessors, one or more microprocessors in conjunction with a DSP core, or any other such configuration).

The computer system 800 may further include a network interface device 810. The computer system 800 also may or may not include an input 812, configured to receive input and selections to be communicated to the computer system 800 when executing instructions. The computer system 800 also may or may not include an output 814, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 800 may or may not include a data storage device that includes instructions 816 stored in a computer-readable medium 818. The instructions 816 may also reside, completely or at least partially, within the main memory 804 and/or within the processing device 802 during execution thereof by the computer system 800, the main memory 804, and the processing device 802 also constituting computer-readable medium. The instructions 816 may further be transmitted or received via the network interface device 810.

While the computer-readable medium 818 is shown in an exemplary embodiment to be a single medium, the term “computer-readable medium” should be taken to include a single medium or multiple media (e.g., a centralized or distributed database, and/or associated caches and servers) that store the one or more sets of instructions 816. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A circuit for a configurable binary neural network (BNN), the circuit comprising a processing element comprising:
a network of binary neurons, wherein each binary neuron has a local register and a plurality of inputs, and is configurable with a threshold function; and
connections between the network of binary neurons such that the network of binary neurons is fully connected.

2. The circuit of claim 1, wherein the network of binary neurons comprises four binary neurons, each having four inputs.

3. The circuit of claim 2, wherein each input of each binary neuron is coupled to a multiplexor providing inter-neuron communication.

4. The circuit of claim 1, wherein each binary neuron further has weights and a threshold, the threshold configuring the threshold function according to a control signal.

5. The circuit of claim 1, wherein the processing element is configurable to perform at least addition, comparison, max-pooling, and rectified linear unit (ReLU) functions.

6. The circuit of claim 1, further comprising a plurality of processing units, each comprising the network of binary neurons.

7. The circuit of claim 6, further comprising a processing unit controller coupled to the plurality of processing units and configured to implement a BNN on the plurality of processing units.

8. A configurable binary neural network (BNN) application-specific integrated circuit (ASIC), comprising:
a processing unit comprising a plurality of processing elements programmable to perform a Boolean threshold function, wherein each of the plurality of processing elements comprises:
a binary neuron with a configurable threshold; and
a local register configured to store an output of the binary neuron; and
a processing unit controller coupled to the processing unit and configured to implement a BNN on the processing unit.

9. The configurable BNN ASIC of claim 8, wherein the processing unit is configurable to perform at least addition, comparison, max-pooling, and rectified linear unit (ReLU) functions.

10. The configurable BNN ASIC of claim 8, wherein each of the plurality of processing elements comprises a plurality of binary neurons, each with a corresponding local register.

11. The configurable BNN ASIC of claim 10, wherein the processing unit is configured to perform different Boolean threshold functions by adjusting the configurable threshold of each binary neuron.

12. The configurable BNN ASIC of claim 8, further comprising a kernel buffer configured to store weights of the BNN.

13. The configurable BNN ASIC of claim 12, wherein the kernel buffer comprises a shift-register.

14. The configurable BNN ASIC of claim 8, further comprising a plurality of processing units controlled by the processing unit controller.

15. The configurable BNN ASIC of claim 14, further comprising an image buffer configured to store input feature maps (IFMs) and provide the IFMs to the plurality of processing units.

16. The configurable BNN ASIC of claim 15, wherein the image buffer comprises:
an L2 buffer configured to load the IFMs from off-chip memory; and
an L1 buffer configured to fetch a window of IFM pixels for an operation of the BNN and broadcast the window to the plurality of processing units.

17. The configurable BNN ASIC of claim 14, wherein the processing unit controller is configured to provide clock gating to deactivate any processing unit not in use during execution of the BNN.

18. A method for programming a binary neural network (BNN) on a binary neuron-based accelerator, the method comprising:
obtaining a BNN expressed as a first network of threshold functions;
decomposing each node of the first network of threshold functions into a second network of threshold functions, wherein a number of inputs of each node in the second network satisfies an input limit; and
scheduling the second network on the binary neuron-based accelerator.

19. The method of claim 18, wherein obtaining the BNN expressed as the first network of threshold functions comprises mapping the BNN to the first network of threshold functions.

20. The method of claim 18, wherein realizing the first network comprises scheduling each node of the first network onto a separate processing element of the binary neuron-based accelerator.
